(19) United States
(12) Patent Application Publication
(10) Pub. No.: US 2026/0025700 A1
(43) Pub. Date: Jan. 22, 2026

(54) BEAM PREDICTION EVALUATION IN COMMUNICATION SYSTEM

(71) Applicant: HUAWEI TECHNOLOGIES CO., LTD., Shenzhen (CN)

(72) Inventors: Majid Gerami, Lund (SE); Thorsten Schier, Lund (SE); Salah Eddine Hajri, Lund (SE); Yuan Li, Beijing (CN)

(73) Assignee: HUAWEI TECHNOLOGIES CO., LTD., Shenzhen (CN)

(21) Appl. No.: 19/343,558

(22) Filed: Sep. 29, 2025

Related U.S. Application Data
(63) Continuation of application No. PCT/CN2023/085563, filed on Mar. 31, 2023.

(51) Int. Cl. H04W 24/10; H04W 24/08

(52) U.S. Cl. CPC H04W 24/10; H04W 24/08

(57) ABSTRACT

Embodiments of the invention relate to beam evaluation for communication devices (100, 300) in a communication system (500). A first communication device (100) jointly encodes a set of benchmark beams for a set of predicted beams to obtain a jointly encoded beam report. The set of benchmark beams are determined based on measured reference signals received from a second communication device (300) in a set of transmit beams of the second communication device (300). The first communication device (100) reports the jointly encoded beam report in a beam report (510) to the second communication device (300). The jointly encoded beam report enables the second communication device (300) to perform beam evaluation in an efficient way with minimal overhead. Furthermore, the invention also relates to corresponding methods and a computer program.

### CROSS-REFERENCE TO RELATED APPLICATIONS

This application is a continuation of International Application No. PCT/CN2023/085563, filed on Mar. 31, 2023, the disclosure of which is hereby incorporated by reference in its entirety.

### TECHNICAL FIELD

Embodiments of the invention relate to evaluation of beam prediction for communication devices in a communication system. Furthermore, embodiments of the invention also relate to corresponding methods and a computer program.

### BACKGROUND

Fifth generation (5G) new radio (NR) is expected to be the first generation of radio access networks that will incorporate extensive use of artificial intelligence (AI)/machine learning (ML) at different levels as part of its specifications. In 5G NR release 17, a RAN3 study item (SI), “Enhancements for Data Collection for NR and EN-DC (FS_NR_ENDC_data_collect)”, is addressing the high level principles, functional framework and use case definitions for AI/ML-enabled next generation radio access network (NG-RAN). Therein, the focus is on higher layer use cases, including load balancing, network energy saving and mobility optimization.

The work on AI/ML in RAN is addressing a wider scope in release 18, including a study item on AI/ML for NR air interface. Therein, the focus is on AI/ML for channel state information (CSI) feedback enhancement, AI/ML for beam management and AI/ML for positioning accuracy enhancement. Additionally, the study includes general framework and model life cycle management aspects.

The scope of the work on AI/ML for the air interface is expected to widen in future releases, with other possible use cases including, among others, link adaptation enhancements, radio resource management, hardware impairment and mobile terminal/next generation NodeB (gNB)-side implementation enhancement, handover, layer 1/layer 2-mobility support enhancement.

Different aspects need to be studied for the design of an efficient AI/ML framework for the air interface. This includes, among others, the impacts of AI/ML methods deployment options, at the user equipment (UE), gNB or jointly at both ends, training options, over the air or offline and at one or multiple devices, inference options, monitoring option.

### SUMMARY

An objective of embodiments of the invention is to provide a solution which mitigates or solves the draw backs and problems of conventional solutions.

Another objective of embodiments of the invention is to provide a solution to enable accurate performance monitoring for predicted precoder.

The above and further objectives are solved by the subject matter of the independent claims. Further embodiments of the invention can be found in the dependent claims.

According to a first aspect of the invention, the above mentioned and other objectives are achieved with a first communication device for a communication system, the first communication device being configured to:
measure reference signals received from a second communication device in a set of transmit beams of the second communication device;
determine a set of benchmark beams for a set of predicted beams based on the measured reference signals;
jointly encode the set of benchmark beams to obtain a jointly encoded beam report; and
transmit a beam report to the second communication device, the beam report indicating the jointly encoded beam report.

An advantage of the first communication device according to the first aspect is that the first communication device can provide the output of different methods for beam determination, in a jointly encoded beam report. The jointly encoded beam report can be used as input for a beam determination model at the second communication device or as a monitoring input to determine the performance of beam determination or prediction models at the first communication device. The joint encoding of the determined benchmark beams further enables to reduce the overhead of the reported quantities, consequently offloading the control channels over the air interface.

In an embodiment of a first communication device according to the first aspect, the first communication device is configured to:
determine the set of benchmark beams based on the measured reference signals and a first beam determination model.

An advantage with this embodiment is that the first communication device can determine one or multiple benchmarks for beam determination. The determination of benchmark beams can be based on measurements on different reference resource sets. A flexible beam determination can thereby be provided.

In an embodiment of a first communication device according to the first aspect, the first beam determination model is an artificial intelligence/machine learning (AI/ML) based model or a non-AI/ML based model.

An advantage with this embodiment is that AI/ML and non-AI/ML based methods can be used, providing flexibility to the solution. The difference between benchmarks can be based on the method used to determine the beams and beam quality quantities. Indeed, for an AI/ML based method, the determined beams and beam quality quantities can be obtained from the output of a beam determination model, in time-domain or space-domain or both. For a non-AI/ML based model, the determined beams can be the best K measured beams, where K is a preconfigured value.

In an embodiment of a first communication device according to the first aspect, the first communication device is configured to:
determine a set of performance metrics for the set of predicted beams based on the set of benchmark beams; and
jointly encode the set of benchmark beams and the set of performance metrics to obtain the jointly encoded beam report.

An advantage with this embodiment is that the first communication device may determine performance metrics for beam prediction, such as beam prediction accuracy or beam quality prediction accuracy, and report them in a jointly encoded beam report. The joint encoding enables to convey all these quantities with a low overhead over the air interface. Depending on where beam prediction monitoring is performed, at the first communication device, the second communication device, or both, the quantities reported in the jointly encoded beam report can be used e.g., as input for AI/ML model monitoring and life cycle management. Thereby, efficient AI/ML model switching, model update, fallback operation, etc. can be provided.

In an embodiment of a first communication device according to the first aspect, the set of performance metrics comprises one or more of: a beam prediction accuracy, a reference signal received power (RSRP) prediction accuracy, a signal to noise and interference ratio (SINR) prediction accuracy, and a mismatch between a predicted beam and a benchmark beam.

An advantage with this embodiment is that different performance metrics can be configured which enables a substantial flexibility in monitoring the performance of beam prediction. Depending on the use case and measurement and reporting configuration, one or more performance metrics could be prioritized. Some use cases may only require beam prediction accuracy, while others may require accurate RSRP or SINR prediction.

In an embodiment of a first communication device according to the first aspect, the first communication device is configured to:
determine a set of beam quality quantities for the set of predicated beams based on the measured reference signals; and
jointly encode the set of benchmark beams, the set of performance metrics, and the set of beam quality quantities to obtain the jointly encoded beam report.

An advantage with this embodiment is that the first communication device can determine quantities that are relevant to both inference and monitoring at the first and/or second communication device and report them in a jointly encoded beam report. The joint encoding enables to convey all these quantities with a low overhead over the air interface. The reported benchmark beams and beam quality quantities can be used to monitor beam determination by the first communication device and, subsequently, perform the appropriate life cycle management actions for the beam determination model at the first communication device. The reported benchmark beams and beam quality quantities can further be used as input for a beam determination model at the second communication device.

In an embodiment of a first communication device according to the first aspect, the first communication device is configured to:
receive a beam evaluation configuration from the second communication device, the beam evaluation configuration indicating one or more of: reference signals to be measured, a benchmark beam, a performance metric, and a first beam determination model; and
measure the reference signals and/or determine the set of benchmark beams and/or determine the set of performance metrics based on the beam evaluation configuration.

An advantage with this embodiment is that the beam evaluation configuration can be used to configure the behavior of the first communication device, for measuring and reporting beam determination benchmarks. The configuration may indicate the same or different measurement resources for the different configured or selected benchmarks. Additionally, the reporting resources and time-domain behavior can be provided in the beam evaluation configuration.

In an embodiment of a first communication device according to the first aspect, the first communication device is configured to:
quantize at least one of the set of benchmark beams, the set of performance metrics and the set of beam quality quantities based on a reference value and/or a reference resource indicator to obtain a quantized jointly encoded beam report.

An advantage with this embodiment is that joint encoding of one or more benchmark beams, beam quality quantities for the benchmark beams, and performance metrics enables to reduce the overhead of the transmitted beam report over the air interface.

In an embodiment of a first communication device according to the first aspect, the reference value is a beam quality quantity for a benchmark beam or a predicted beam, and the reference resource indicator is a resource indicator for a benchmark beam or a predicted beam.

An advantage with this embodiment is that using reference beam quality quantity values and reference resource indicators, for joint encoding or quantization, enables to center the dynamic range of the reported values so that better quantization accuracy is achieved, without requiring an increase in overhead.

In an embodiment of a first communication device according to the first aspect,
the set of transmit beams of the second communication device is a set of all transmit beams of the second communication device or a subset of the set of all transmit beams of the second communication device.

An advantage with this embodiment is that the proposed method can support different beam codebooks, different reference signal resources overhead, different device capabilities and different reporting overhead over the air interface.

In an embodiment of a first communication device according to the first aspect, the first communication device is configured to:
transmit the beam report to the second communication device upon reception of a trigger signal from the second communication device.

An advantage with this embodiment is that semi-persistent or aperiodic reporting are supported, which enables considerable flexibility in determining the timeline of jointly encoded beam reports.

In an embodiment of a first communication device according to the first aspect, the first communication device is configured to:
transmit the beam report to the second communication device upon determining a lack of computation, energy or transmission resources for the first communication device.

An advantage with this embodiment is that event-triggered reporting is supported for jointly encoded beam reports, wherein the event includes conditions on the available resources at the first communication device.

In an embodiment of a first communication device according to the first aspect, the first communication device is configured to:
transmit the beam report to the second communication device upon determining that a performance metric for a benchmark beam is higher than a performance metric of the first beam determination model, or upon detecting a drop in a performance metric for a benchmark beam below a preconfigured performance metric threshold.

An advantage with this embodiment is that event-triggered reporting is supported for jointly encoded beam reports, wherein the event includes conditions on the performance of the different beam determination methods and models.

In an embodiment of a first communication device according to the first aspect, the first communication device is configured to:
transmit a pre-report message to the second communication device prior to transmitting the beam report, the pre-report message indicating a reporting format of the beam report.

An advantage with this embodiment is that jointly encoded beam reports with variable payload can be supported. By indicating the reporting format in the pre-report message, ambiguities in the size of the jointly encoded beam report can be avoided.

In an embodiment of a first communication device according to the first aspect, the set of predicted beams comprises any of: a set of receive beams of the first communication device, a set of transmit beams of the second communication device, or a set of beam pairs where each beam pair comprises a receive beam of the first communication device and a transmit beam of the second communication device.

An advantage with this embodiment is that different implementations can be supported, including, transmit beam, receive beam and beam pair prediction.

According to a second aspect of the invention, the above mentioned and other objectives are achieved with a second communication device for a communication system, the second communication device being configured to:
transmit reference signals to a first communication device in a set of transmit beams of the second communication device;
receive a beam report from the first communication device, the beam report being a jointly encoded beam report for a set of predicted beams, the jointly encoded beam report being encoded based on a set of benchmark beams; and
determine a beam evaluation for the set of predicted beams based on the beam report.

An advantage of the second communication device according to the second aspect is that the second communication device can use the received jointly encoded report as input for a beam determination model at the second communication device or as a monitoring input to determine the performance of beam determination or prediction models at the first communication device. The joint encoding of the determined benchmark beams further enables to reduce the overhead of the reported quantities, consequently offloading the control channels over the air interface.

In an embodiment of a second communication device according to the second aspect, the second communication device is configured to:
determine the beam evaluation for the set of predicted beams based on the beam report and a second beam determination model for the set of predicted beams.

An advantage with this embodiment is that the second communication device can use the received jointly encoded report as input for a beam determination model at the second communication device. The second communication device can then compare its prediction with the one obtained at the first communication device, and consequently assess the performance of beam determination methods and models at the first communication device.

In an embodiment of a second communication device according to the second aspect, the second beam determination model is an AI/ML based model or a non-AI/ML based model.

An advantage with this embodiment is that AI/ML and non-AI/ML based methods can be used, providing flexibility to the solution. The difference between benchmarks can be based on the method used to determine the beams and beam quality quantities. Indeed, for an AI/ML based method, the determined beams and beam quality quantities can be obtained from the output of a beam determination model, in time-domain or space-domain or both. For a non-AI/ML based model, the determined beams can be the best K measured beams, where K is preconfigured.

In an embodiment of a second communication device according to the second aspect, the second communication device is configured to:
adapt the second beam determination model based on the determined beam evaluation.

An advantage with this embodiment is that the second communication device can use the received jointly encoded beam report in order to select the appropriate model life cycle management action for the beam determination models. Model life cycle management actions include model update, switching, fallback, among others.

In an embodiment of a second communication device according to the second aspect, the encoded beam report is further encoded based on a set of performance metrics for the set of predicted beams.

An advantage with this embodiment is that performance metrics for beam prediction, such as beam prediction accuracy or beam quality prediction accuracy, can be reported in the jointly encoded beam report. The joint encoding enables to convey all these quantities with a low overhead over the air interface. The performance metrics reported in the jointly encoded beam report can be used e.g., as input for AI/ML model monitoring and life cycle management at the first communication device, the second communication device, or both.

In an embodiment of a second communication device according to the second aspect, the set of performance metrics comprises one or more of: a beam prediction accuracy, a RSRP prediction accuracy, a SINR prediction accuracy, and a mismatch between a predicted beam and a benchmark beam.

An advantage with this embodiment is that different performance metrics can be configured which enables a substantial flexibility in monitoring the performance of beam prediction. Depending on the use case and measurement and reporting configuration, one or more performance metrics could be prioritized. Some use cases may only require beam prediction accuracy, while others may require accurate RSRP or SINR prediction.

In an embodiment of a second communication device according to the second aspect, the encoded beam report is further encoded based on a set of beam quality quantities for the set of predicated beams.

An advantage with this embodiment is that beam quality quantities that are relevant to both inference and monitoring at the first and/or second communication device can be reported in the jointly encoded beam report. The joint encoding enables to convey all these quantities with a low overhead over the air interface. The beam quality quantities reported in the jointly encoded beam report can be used e.g., as input for AI/ML model monitoring and life cycle management at the first communication device, the second communication device, or both.

In an embodiment of a second communication device according to the second aspect, the second communication device is configured to:
determine a beam evaluation configuration for the first communication device based on the determined beam evaluation, the beam evaluation configuration indicating one or more of: reference signals to be measured, a benchmark beam, a performance metric, and a first beam determination model; and
transmit the beam evaluation configuration to the client device.

An advantage with this embodiment is that the beam evaluation configuration can be used to configure the behavior of the first communication device, for measuring and reporting beam determination benchmarks. The configuration may indicate the same or different measurement resources for the different configured or selected benchmarks. Additionally, the reporting resources and time-domain behavior can be provided in the beam evaluation configuration.

In an embodiment of a second communication device according to the second aspect, the jointly encoded beam report is a quantized beam report comprising at least one of the set of benchmark beams, the set of performance metrics and a set of beam quality quantities quantized based on a reference value and/or a reference resource indicator.

An advantage with this embodiment is that joint encoding of one or more benchmark beams, beam quality quantities for the benchmark beams, and performance metrics enables to reduce the overhead of the transmitted beam report over the air interface.

In an embodiment of a second communication device according to the second aspect, the reference value is a beam quality quantity for a benchmark beam or a predicted beam, and the reference resource indicator is a resource indicator for a benchmark beam or a predicted beam.

An advantage with this embodiment is that using reference beam quality quantity values and reference resource indicators, for joint encoding or quantization, enables to center the dynamic range of the reported values so that better quantization accuracy is achieved, without requiring an increase in overhead.

In an embodiment of a second communication device according to the second aspect, the set of transmit beams of the second communication device is a set of all transmit beams of the second communication device or a subset of the set of all transmit beams of the second communication device.

An advantage with this embodiment is that the proposed method can support different beam codebooks, different reference signal resources overhead, different device capabilities and different reporting overhead over the air interface.

In an embodiment of a second communication device according to the second aspect, the second communication device is configured to:
transmit a trigger signal to the first communication device, the trigger signal indicating the first communication device to transmit the beam report.

An advantage with this embodiment is that semi-persistent or aperiodic reporting are supported, which enables considerable flexibility in determining the timeline of jointly encoded beam reports.

In an embodiment of a second communication device according to the second aspect, the second communication device is configured to:
receive a pre-report message from the first communication device prior to receiving the beam report, the pre-report message indicating a reporting format of the beam report.

An advantage with this embodiment is that jointly encoded beam reports with variable payload can be supported. By indicating the reporting format in the pre-report message, ambiguities in the size of the jointly encoded beam report can be avoided.

In an embodiment of a second communication device according to the second aspect, the set of predicted beams comprises any of: a set of receive beams of the first communication device, a set of transmit beams of the second communication device, or a set of beam pairs where each beam pair comprises a receive beam of the first communication device and a transmit beam of the second communication device.

An advantage with this embodiment is that different implementations can be supported, including transmit beam, receive beam and beam pair prediction.

According to a third aspect of the invention, the above mentioned and other objectives are achieved with a method for a first communication device, the method comprises:
measuring reference signals received from a second communication device in a set of transmit beams of the second communication device;
determining a set of benchmark beams for a set of predicted beams based on the measured reference signals;
jointly encoding the set of benchmark beams to obtain a jointly encoded beam report; and
transmitting a beam report to the second communication device, the beam report indicating the jointly encoded beam report.

The method according to the third aspect can be extended into embodiments corresponding to the embodiments of the first communication device according to the first aspect. Hence, an embodiment of the method comprises the feature(s) of the corresponding embodiment of the first communication device.

The advantages of the methods according to the third aspect are the same as those for the corresponding embodiments of the first communication device according to the first aspect.

According to a fourth aspect of the invention, the above mentioned and other objectives are achieved with a method for a second communication device, the method comprises
transmitting reference signals to a first communication device in a set of transmit beams of the second communication device;
receiving a beam report from the first communication device, the beam report being a jointly encoding beam report for a set of predicted beams, the jointly encoded beam report being encoded based on a set of benchmark beams; and
determining a beam evaluation for the set of predicted beams based on the beam report.

The method according to the fourth aspect can be extended into embodiments corresponding to the embodiments of the second communication device according to the second aspect. Hence, an embodiment of the method comprises the feature(s) of the corresponding embodiment of the second communication device.

The advantages of the methods according to the fourth aspect are the same as those for the corresponding embodiments of the second communication device according to the second aspect.

Embodiments of the invention also relate to a computer program, characterized in program code, which when run by at least one processor causes the at least one processor to execute any method according to embodiments of the invention. Further, embodiments of the invention also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the invention will be apparent from the following detailed description.

### BRIEF DESCRIPTION OF THE DRAWINGS

The appended drawings are intended to clarify and explain different embodiments of the invention, in which:

FIG. 1 shows a first communication device according to an embodiment of the invention;

FIG. 2 shows a flow chart of a method for a first communication device according to an embodiment of the invention;

FIG. 3 shows a second communication device according to an embodiment of the invention;

FIG. 4 shows a flow chart of a method for a second communication device according to an embodiment of the invention;

FIG. 5 shows a communication system according to an embodiment of the invention;

FIG. 6 shows beam evaluation according to an embodiment of the invention;

FIG. 7 shows quantization of a beam report according to an embodiment of the invention;

FIG. 8 shows beam evaluation triggered by a second communication device according to an embodiment of the invention; and

FIG. 9 shows beam evaluation triggered by a first communication device according to an embodiment of the invention.

### DETAILED DESCRIPTION

To evaluate the performance of AI/ML models and derive the gap between AI/ML prediction and the actual value, AI/ML performance monitoring functionality is important. AI/ML performance monitoring can be performed at the network side and/or the UE side. Depending on whether the AI/ML model is at the network side and/or the UE side, different signaling or measurement reports should be transmitted. The AI/ML performance monitoring procedures also depend on the metrics of interest, i.e., whether it is based on final key performance indicators (KPIs) or intermediate KPIs.

Performance monitoring is an essential part of AI/ML processes. It controls the quality of prediction in an AI/ML system and provides a critical input for model updating and adaptation. Similarly, in a beam management process based on AI/ML model, the function of performance monitoring guarantees the quality of the beam prediction process and enables to reduce beam failure probability.

There have been discussions in previous third generation partnership program (3GPP) meetings on which benchmarks to be used and which performance metrics to be considered for performance comparison. Each benchmark or performance metric can be useful in specific scenarios and/or radio conditions. For the network side to obtain a good perception of the AL/ML performance, multiple reports may hence be required. A straightforward approach based on the current NR standard would be for the UE to report the requested benchmark or performance metric separately, i.e., the UE transmits multiple separate reports to the network side. This can increase overhead and latency in obtaining the performance of AI/ML models. Another problem would be the amount of data that is transmitted from the UE to the network, or from the UE to another UE, for performance monitoring.

According to embodiments of the invention a solution to report multiple benchmarks and/or performance metrics from a first communication device to a second communication device with a reduced overhead is therefore provided. This adds flexibility to the reporting of benchmarks and/or performance metrics. In addition, the overhead and the amount of transmitted data from the first communication device to the second communication device is reduced.

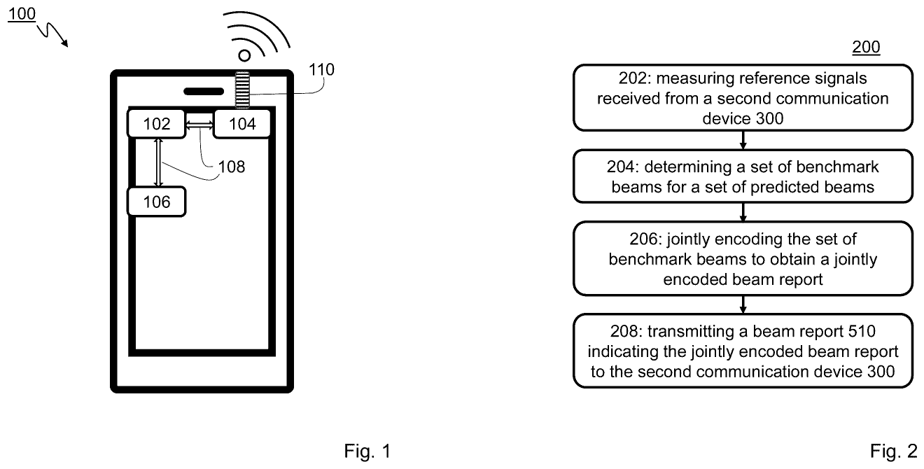

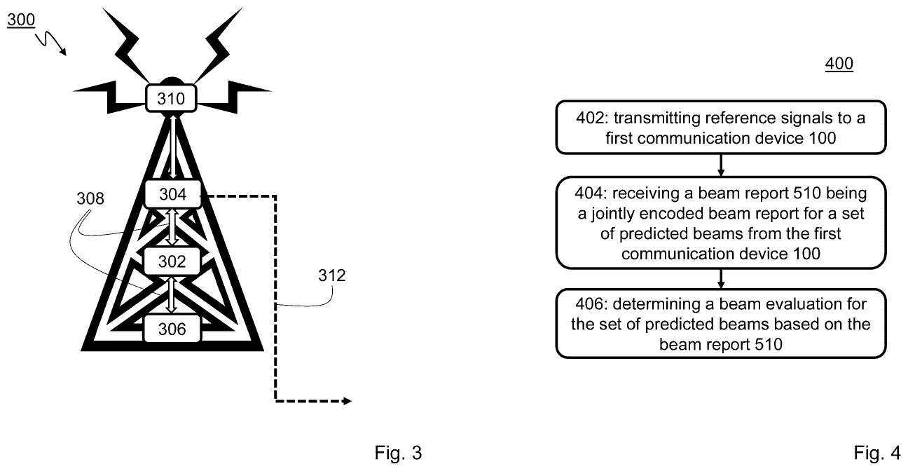

FIG. 1 shows a first communication device 100 according to an embodiment of the invention where the first communication device 100 is a client device. However, the first communication device 100 is not limited thereto and may in embodiments instead be a network access node, such as e.g., the network access node shown in FIG. 3. In the embodiment shown in FIG. 1, the first communication device 100 comprises a processor 102, a transceiver 104 and a memory 106. The processor 102 is coupled to the transceiver 104 and the memory 106 by communication means 108 known in the art. The first communication device 100 further comprises an antenna or antenna array 110 coupled to the transceiver 104, which means that the first communication device 100 is configured for wireless communications in a communication system.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 304 may be a transceiver circuit, a power controller, or an interface providing capability to communicate with other communication modules or communication devices, such as network nodes and network servers. The transceiver 104, memory 106 and/or processor 102 may be implemented in separate chipsets or may be implemented in a common chipset.

That the first communication device 100 is configured to perform certain actions can in this disclosure be understood to mean that the first communication device 100 comprises suitable means, such as e.g., the processor 102 and the transceiver 104, configured to perform the actions.

According to embodiments of the invention the first communication device 100 is configured to measure reference signals received from a second communication device 300 in a set of transmit beams of the second communication device 300. The first communication device 100 is further configured to determine a set of benchmark beams for a set of predicted beams based on the measured reference signals and jointly encode the set of benchmark beams to obtain a jointly encoded beam report. Furthermore, the first communication device 100 is configured to transmit a beam report 510 to the second communication device 300, the beam report 510 indicating the jointly encoded beam report.

Furthermore, in an embodiment of the invention, the first communication device 100 for a communication system 500 comprises: a processor configured to measure reference signals received from a second communication device 300 in a set of transmit beams of the second communication device 300; determine a set of benchmark beams for a set of predicted beams based on the measured reference signals; and jointly encode the set of benchmark beams to obtain a jointly encoded beam report. The first communication device 100 further comprises a transceiver configured to transmit a beam report 510 to the second communication device 300, the beam report 510 indicating the jointly encoded beam report.

Moreover, in yet another embodiment of the invention, the first communication 100 for a communication system 500 comprises a processor and a memory having computer readable instructions stored thereon which, when executed by the processor, cause the processor to: measure reference signals received from a second communication device 300 in a set of transmit beams of the second communication device 300; determine a set of benchmark beams for a set of predicted beams based on the measured reference signals: jointly encode the set of benchmark beams to obtain a jointly encoded beam report; and transmit a beam report 510 to the second communication device 300, the beam report 510 indicating the jointly encoded beam report.

FIG. 2 shows a flow chart of a corresponding method 200 which may be executed in a first communication device 100, such as the one shown in FIG. 1. The method 200 comprises measuring 202 reference signals received from a second communication device 300 in a set of transmit beams of the second communication device 300. The method 200 further comprises determining 204 a set of benchmark beams for a set of predicted beams based on the measured reference signals and jointly encoding 206 the set of benchmark beams to obtain a jointly encoded beam report. The method 200 further comprises transmitting 208 a beam report 510 to the second communication device 300, the beam report 510 indicating the jointly encoded beam report.

FIG. 3 shows a second communication device 300 according to an embodiment of the invention where the second communication device 300 is a network access node. However, the second communication device 300 is not limited thereto and may in embodiments instead be a client device, such as e.g., the client device shown in FIG. 1. In the embodiment shown in FIG. 3, the second communication device 300 comprises a processor 302, a transceiver 304 and a memory 306. The processor 302 is coupled to the transceiver 304 and the memory 306 by communication means 308 known in the art. The second communication device 300 may be configured for wireless and/or wired communications in a communication system. The wireless communication capability may be provided with an antenna or antenna array 310 coupled to the transceiver 304, while the wired communication capability may be provided with a wired communication interface 312 e.g., coupled to the transceiver 304.

The processor 302 may be referred to as one or more general-purpose CPUs, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 104 may be a transceiver circuit, a power controller, or an interface providing capability to communicate with other communication modules or communication devices. The transceiver 304, the memory 306 and/or the processor 302 may be implemented in separate chipsets or may be implemented in a common chipset.

That the second communication device 300 is configured to perform certain actions can in this disclosure be understood to mean that the second communication device 300 comprises suitable means, such as e.g., the processor 302 and the transceiver 304, configured to perform the actions.

According to embodiments of the invention the second communication device 300 is configured to transmit reference signals to a first communication device 100 in a set of transmit beams of the second communication device 300. The second communication device 300 is further configured to receive a beam report 510 from the first communication device 100, the beam report 510 being a jointly encoded beam report for a set of predicted beams, the jointly encoded beam report being encoded based on a set of benchmark beams. The second communication device 300 is further configured to determine a beam evaluation for the set of predicted beams based on the beam report 510.

Furthermore, in an embodiment of the invention, the second communication device 300 for a communication system 500 comprises: a transceiver configured to transmit reference signals to a first communication device 100 in a set of transmit beams of the second communication device 300 and receive a beam report 510 from the first communication device 100, the beam report 510 being a jointly encoded beam report for a set of predicted beams, the jointly encoded beam report being encoded based on a set of benchmark beams. The second communication device 300 further comprises a processor configured to determine a beam evaluation for the set of predicted beams based on the beam report 510.

Moreover, in yet another embodiment of the invention, the second communication device 300 for a communication system 500 comprises a processor and a memory having computer readable instructions stored thereon which, when executed by the processor, cause the processor to: transmit reference signals to a first communication device 100 in a set of transmit beams of the second communication device 300: receive a beam report 510 from the first communication device 100, the beam report 510 being a jointly encoded beam report for a set of predicted beams, the jointly encoded beam report being encoded based on a set of benchmark beams; and determine a beam evaluation for the set of predicted beams based on the beam report 510.

FIG. 4 shows a flow chart of a corresponding method 400 which may be executed in a second communication device 300, such as the one shown in FIG. 3. The method 400 comprises transmitting 402 reference signals to a first communication device 100 in a set of transmit beams of the second communication device 300. The method 400 further comprises receiving 404 a beam report 510 from the first communication device 100, the beam report 510 being a jointly encoded beam report for a set of predicted beams, the jointly encoded beam report being encoded based on a set of benchmark beams. The method 400 further comprises determining 406 a beam evaluation for the set of predicted beams based on the beam report 510.

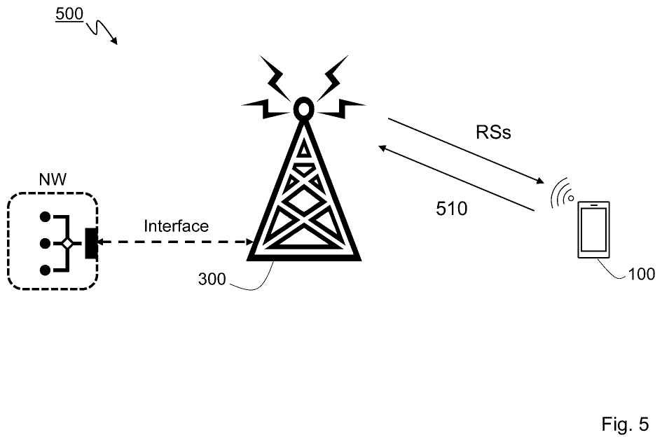

FIG. 5 shows a communication system 500 according to an embodiment of the invention. The communication system 500 in the disclosed embodiment comprises a first communication device 100 and a second communication device 300 configured to communicate and operate in the communication system 500. In the shown embodiment, the first communication device 100 is configured as a client device and the second communication device 300 is configured as a network access node. However, in embodiments the first communication device 100 may instead be configured as a network access node and the second communication device 300 may be configured as a client device or both the first communication device 100 and the second communication device 300 may be configured as client devices. A communication device 100, 300 being a network access node may be connected to a network NW such as e.g., a core network over a communication interface. The communication system 500 may be a communication system according to the 3GPP standard such as e.g., a 5G system in which case the client device may be a UE and the network access node may be a next generation node B (gNB) but the invention is not limited thereto.

The first communication devices 100 and the second communication devices 300 communicate with each other over radio channels. The radio channels may be used for one or more of uplink, downlink, and sidelink communication depending on whether the first communication device 100 and the second communication device 300 are client devices and/or network access nodes. In case of a 5G system, the uplink/downlink communication may be performed over the Uu interface and the sidelink communication over the PC5 interface.

AI/ML models may be used for the communication sessions over the radio channels between the first communication devices 100 and the second communication devices 300. The AI/ML models may be used to perform physical layer operations such as e.g., beam measurements and selection of suitable transmit and/or receive beams. Given mobility of communication devices 100, 300 configured as client devices and the dynamic nature of radio channels and traffic characteristics, the performance of an AI/ML model used to perform physical layer operations may degrade over time or fall below target performance. Input drift due to change in the large-scale parameters of the radio channel, e.g., spatial and delay supports, or change in the traffic requirements may necessitate a change in link adaptation, radio resources measurements, resource allocation policies, among others, and subsequently an adaptation of active AI/ML models.

Embodiments of the invention enables performance monitoring for beam evaluation based on a set of benchmark beams. In this respect, the first communication device 100 measures reference signals RSs received from the second communication device 300 in a set of transmit beams of the second communication device 300. Based on the measured reference signals RSs, the first communication device 100 determines a set of benchmark beams for a set of predicted beams and jointly encodes the set of benchmark beams to obtain a jointly encoded beam report. With the jointly encoded beam report the determined set of benchmark beams for the set of predicted beams may be indicated in an efficient way. With reference to FIG. 5, the first communication device 100 then transmits a beam report 510 to the second communication device 300. The beam report 510 indicates the jointly encoded beam report and thereby informs the second communication device 300 about the set of benchmark beams determined by the first communication device 100.

Based on the beam report 510, the second communication device 300 may determine a beam evaluation for the set of predicted beams. For example, assuming multiple beam determination models for predicting beams at the first communication device 100, the first communication device 100 may use one beam determination model to determine the predicted beams and the other beam determination models to determine benchmark beams. In this case, the jointly encoded beam report may include, the set of top-K predicted beams by each beam determination model, the predicted reference signal received power (RSRP) for the top-K predicted beams by each beam determination model, and the top-K beams and their associated RSRP values, determined by measurements on a set of reference signal resources. In this way, the second communication device 300 can evaluate the performance of the set of predicted beams and make adaptations to beam determination models, at the first and/or second communication device, if the performance deteriorate.

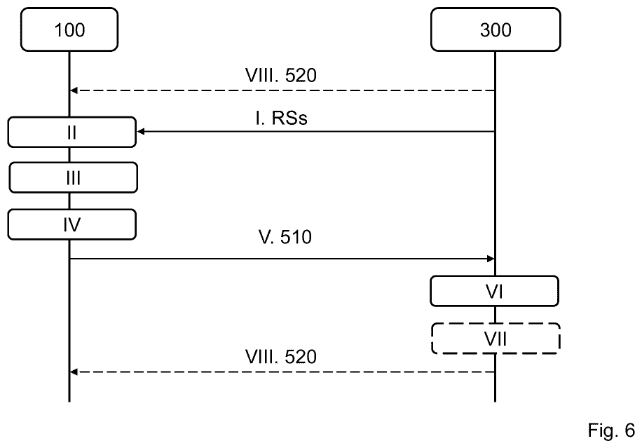

FIG. 6 shows signaling for beam evaluation between a first communication device 100 and a second communication device 300 according to an embodiment of the invention. The first communication device 100 and/or a second communication device 300 may be a client device or a network access node.

In operation I in FIG. 6, the second communication device 300 transmits reference signals RSs to the first communication device 100 in a set of transmit beams of the second communication device 300. When the second communication device 300 is a network access node, the reference signals RSs may be downlink reference signals transmitted on downlink resources by the second communication device 300. When the second communication device 300 is a client device, the reference signals RSs may be uplink or sidelink reference signals transmitted on uplink or sidelink resources by the second communication device 300. The reference signals RSs may e.g., be synchronization signal blocks (SSBs) or channel state information-reference signal (CSI-RS) resources for beam measurement.

In operation II in FIG. 6, the first communication device 100 receives the reference signals RSs in the set of transmit beams of the second communication device 300 and measures the reference signals RSs received from the second communication device 300 in the set of transmit beams of the second communication device 300. The set of transmit beams of the second communication device 300 may a set of all transmit beams of the second communication device 300 or a subset of the set of all transmit beams of the second communication device 300. Thus, the first communication device 100 may measure all or a subset of the transmit beams used by the second communication device 300. The first communication device 100 may e.g., based on configuration or device-centric selection, determine a subset of the set of all transmit beams of the second communication device 300 to measure. The measured subset can be selected based on its quasi co-location (QCL) relation with SSB signals or based on prior measurements on the same or different reference signals.

In operation III in FIG. 6, the first communication device 100 determines a set of benchmark beams for a set of predicted beams based on the measured reference signals. The set of predicted beams may comprise any of: a set of receive beams of the first communication device 100, a set of transmit beams of the second communication device 300, or a set of beam pairs where each beam pair comprises a receive beam of the first communication device 100 and a transmit beam of the second communication device 300. The first communication device 100 may hence determine benchmark beams for receive beams, transmit beams and/or beam pairs.

In embodiments, the first communication device 100 determines the set of benchmark beams based on the measured reference signals and a first beam determination model. The first beam determination model may be an AI/ML based model or a non-AI/ML based model. The AI/ML based model may e.g., be a neural network for beam prediction in time and/or space domain. The first communication device 100 may have multiple beam determination models in use, one can be taken as the active model and the others are used to establish benchmarks, i.e., a set of predicted beams/beam pairs and their corresponding beam quality quantities.

The non-AI/ML based model may be based on a non-AI/ML based algorithm such as e.g., a sample-and-hold algorithm. Non-AI/ML based models for beam prediction may be based on current measurements or use of linear prediction methods, such as Kalman filter. For example, two types of benchmark beams may be considered a genie-aided upper bound or a non-AI/ML lower bound. The former, refers to deriving the best beams or beam pair, following the measurements of all beams or beam pairs and the latter refer to a conventional approach where only a subset of the measurement resources is use. The first communication device 100 may e.g., determine a benchmark beam based on a genie-aided best beam which is derived as the best beam obtained from the measured reference signals. This may be regarded as the upper bound. The first communication device 100 may further determine a benchmark beam under a non-AI/ML solution, e.g., under comparable beam sweeping overhead and/or latency with the AI/ML solution being monitored. This may be regarded as the lower bound.

The upper bound can be used to determine the absolute value of a beam prediction accuracy for the AI/ML solution, while the lower bound can be used to compare the performance, including beam prediction accuracy KPI and/or link quality KPI, of the AI/ML solution. Based on the relative performance to the lower bound, the first communication device 100 and/or the second communication device 300 may determine whether to continue the operation of an activated AI/ML model or to deactivate the AI/ML model and fall back to legacy.

In embodiments, the first communication device 100 may determines multiple sets of benchmark beams, where each set of benchmark beams is determined based on the measured reference signals and a respective first beam determination model. Thus, different first beam determination models may be used to determine different sets of benchmark beams. However, one first beam determination model may further be used to determines multiple sets of benchmark beams, i.e., one and the same first beam determination model may result in different sets of benchmark beams. For example, one set of benchmark beams for a lower bound benchmark and one set of benchmark beams for an upper bound benchmark.

In addition to the set of benchmark beams for the set of predicted beams, the first communication device 100 may determine a set of performance metrics for the set of predicted beams based on the set of benchmark beams. The set of performance metrics may comprise one or more of: a beam prediction accuracy, a RSRP prediction accuracy, a signal to noise and interference ratio (SINR) prediction accuracy, and a mismatch between a predicted beam and a benchmark beam.

The beam prediction accuracy may be determined based on one or more of: Top-1(%): the percentage of “the Top-1 genie-aided beam is Top-1 predicted beam”; Top-K/1(%): the percentage of “the Top-1 genie-aided beam is one of the Top-K predicted beams”; Top-1/K (%) (Optional): the percentage of “the Top-1 predicted beam is one of the Top-K genie-aided beams”; Top-K/−1(%) the percentage of “the Top-K predicted beam is one of the Top-1 genie-aided beams”; Where K>1 and values can be reported by companies. The RSRP prediction accuracy may indicate a gap in RSRP and be determined based on a comparison between the RSRP of an AI/ML predicted beam and the RSRP of a genie-aided beam. SINR prediction accuracy may indicate a gap in SINR and be determined based on a comparison between the SINR of an AI/ML predicted beam and the RSRP of a genie-aided beam.

Based on the measured reference signals, the first communication device 100 may further determine a set of beam quality quantities for the set of predicated beams. The set of beam quality quantities may be determined based on the measured reference signals and one or more beam determination models such as e.g., the first beam determination model. Beam quality quantities include RSRP and L1-SINR. When determining predicted beams, the first communication device 100 may use an AI/ML based model, e.g. neural network with long short-term memory (LSTM) layers, to predict RSRP and/or SINR values for beams in a first set, taking as input RSRP and/or SINR values for beams in a second set, namely, inference input set. Depending on whether beams and beam quality quantities are predicted in space-domain or time domain, measurements on received downlink reference signal over a period of time can be used as inference input.

In operation IV in FIG. 6, the first communication device 100 obtains a jointly encoded beam report based on one or more of the set of benchmark beams, the set of performance metrics and the set of beam quality quantities determined by the first communication device 100 in operation III in FIG. 6. The first communication device 100 may jointly encode the set of benchmark beams to obtain a jointly encoded beam report. The first communication device 100 may further jointly encode the set of benchmark beams and the set of performance metrics to obtain the jointly encoded beam report or jointly encode the set of benchmark beams, the set of performance metrics, and the set of beam quality quantities to obtain the jointly encoded beam report. The jointly encoded beam report determined by the first communication device 100 may hence comprise benchmark beams, performance metrics, beam quality quantities or any combination of benchmark beams, performance metrics and beam quality quantities. For example, the jointly encoded beam report may comprise at least two benchmark beams, at least two performance metrics, at least two beam quality quantities, at least one benchmark beam and at least one performance metric, at least one benchmark beam and at least one beam quality quantities or at least one performance metric and at least one beam quality quantities which have been jointly encoded.

In embodiments, the first communication device 100 may quantize at least one of the set of benchmark beams, the set of performance metrics and the set of beam quality quantities based on a reference value and/or a reference resource indicator to obtain a quantized jointly encoded beam report. For example, a differential quantization may be performed with respect to a reference value and/or a reference resource indicator. The reference value may be a beam quality quantity for a benchmark beam or a predicted beam, and the reference resource indicator may be a resource indicator for a benchmark beam or a predicted beam. For the set of benchmark beams one or multiple reference resource indicators may be used for differential quantization. For example, a reference CSI-RS resource indicator (CRI) for all encoded CRIs, e.g., the one with the highest RSRP overall, or multiple reference CRIs, one for each order statistic of RSRP. For the set of performance metrics, the reference value may e.g., be the highest or lowest performance metric value overall. For the set of beam quality quantities, the reference value(s) may e.g., be maximum RSRP overall, maximum and minimum RSRP, maximum RSRP per order statistic of RSRP.

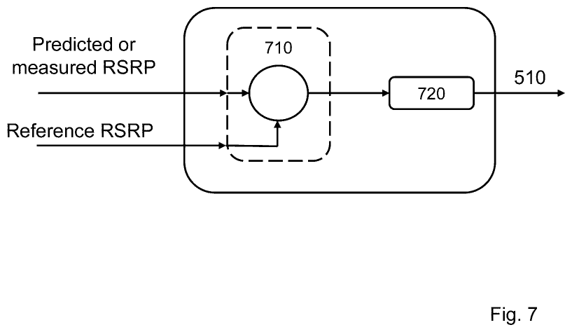

FIG. 7 shows further details related to the quantized jointly encoded beam report according to an embodiment of the invention. In the shown embodiment, a beam report 510 indicating a quantized jointly encoded beam report is obtained by first differentiating e.g., a measured RSRP for a transmit beam in the set transmit beams or a predicted RSRP for the transmit beam in the set of transmit beams, and a reference RSRP using a differentiation function 710.

The reference RSRP can be selected, among others, as the highest, lowest or medium measured or predicted RSRP for multiple benchmark beams. The output from the differentiation function 710 is then quantized using a quantization function 720 to obtain the beam report 510. Joint encoding is used in order to reduce the overhead needed to convey the prediction of the active determination model, measurement results and the prediction of multiple benchmarks.

Table 1 shows an example of a jointly encoded beam report 510 carrying the beam prediction of the first beam determination model, the active model, and N benchmark beams. In Table 1, the output, CRIs and RSRPs, of the first beam determination model is taken as reference. The coefficients for the measurement based benchmark beams and all other determination model-based benchmark beams, are quantized differentially with respect to the corresponding reference values. Differential quantization may be performed with a reduced number of bits, as it needs to cover a smaller dynamic range around the reference values. This means that the jointly encoded beam report necessitates less overhead than reporting benchmarks in several beam reports. The number of quantization bits for differential resource indicators and beam quality quantities may differ and may both be configured so that there is no ambiguity in the bit-width of each coefficient.

TABLE 1

| Prediction | Measurement | Alternative | | Alternative |
|---|---|---|---|---|
| output of | based | determination | | determination |
| active model | benchmark | model #1 | . . . | model #N |
| CRI #0 | Differential | Differential | . . . | Differential |
| | CRI #0 | CRI #4 | | CRI #4N |
| . . . | . . . | . . . | . . . | . . . |
| CRI #3 | Differential | Differential | . . . | Differential |
| | CRI #3 | CRI #7 | | CRI #4N + 3 |
| RSRP #0 | Differential | Differential | . . . | RSRP #4N |
| | RSRP #0 | RSRP #4 | | |
| . . . | . . . | . . . | . . . | . . . |
| RSRP #3 | Differential | Differential | . . . | RSRP #4N + 3 |
| | RSRP #3 | RSRP #7 | | |

In operation V in FIG. 6, the first communication device 100 transmits a beam report 510 to the second communication device 300. The beam report 510 indicates the jointly encoded beam report. Using the beam report 510, the first communication device 100 may hence report the determined benchmark beams, performance metrics and beam quality quantities to the second communication device 300 in a compact way to reduce overhead. The first communication device 100 may transmit the beam report 510 periodically, aperiodically, in a semi-persistent manner or an event-triggered manner. The first communication device 100 may be configured to transmit the beam report 510 in one or more of the above listed ways e.g., by the second communication device 300.

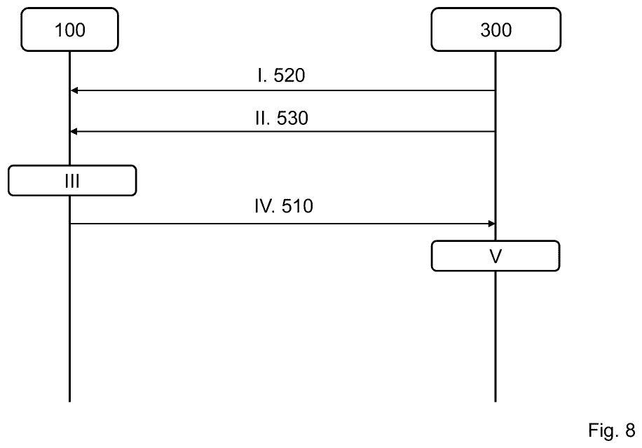

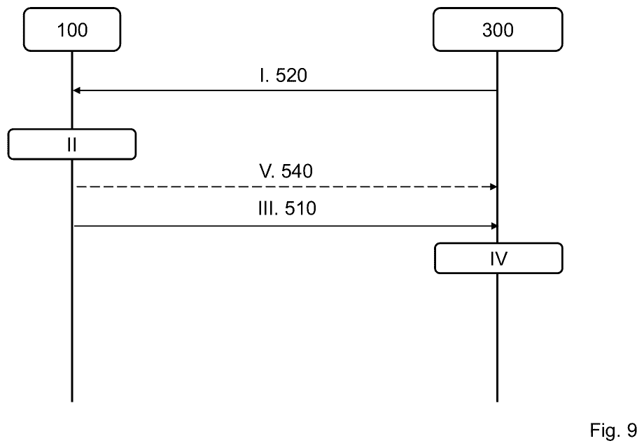

In embodiments, the first communication device 100 may transmits the beam report 510 upon reception of a trigger signal 530 from the second communication device 300, as is further described below with reference to FIG. 8. The first communication device 100 may further transmits the beam report 510 based on a lack of resources for the first communication device 100 and/or based on a condition or criterion, as is further described below with reference to FIG. 9.

With reference to FIG. 6, the second communication device 300 receives the beam report 510 from the first communication device 100 and hence obtains the jointly encoded beam report for the set of predicted beams indicated in the beam report 510. The jointly encoded beam report being encoded based on one or more of the set of benchmark beams for the set of predicted beams, the set of performance metrics for the set of predicted beams and the set of beam quality quantities for the set of predicated beams. From the jointly encoded beam report, the second communication device 300 may hence derive one or more of the set of benchmark beams, the set of performance metrics and the set of beam quality quantities determined by the first communication device 100.

As previously described, the jointly encoded beam report may in embodiments be a quantized beam report comprising at least one of the set of benchmark beams, the set of performance metrics and a set of beam quality quantities quantized based on a reference value and/or a reference resource indicator, where the reference value may a beam quality quantity for a benchmark beam or a predicted beam, and the reference resource indicator may be a resource indicator for a benchmark beam or a predicted beam.

Based on the beam report 510, the second communication device 300 determines a beam evaluation for the set of predicted beams in operation VI in FIG. 6. The second communication device 300 may hence evaluate the performance of the set of predicted beams based on the one or more sets of benchmark beams, performance metrics and beam quality quantities obtained from the beam report 510. In the case where multiple beam determination models are available at the first communication device 100, the active beam determination model can be used as a reference and its performance compared to the other beam determination models, which are taken as benchmarks. Additionally, the performance of measurement based beam determination can also be taken as benchmark.

The second communication device 300 compares the results and decides whether to trigger update or switching of the active beam determination model or to trigger fall back to measurement-based beam determination.

In embodiments, the second communication device 300 may determine the beam evaluation for the set of predicted beams based on the beam report 510 and a second beam determination model for the set of predicted beams. The second communication device 300 may e.g., compare the obtained one or more sets of benchmark beams, performance metrics and beam quality quantities with predicted values obtained from the second beam determination model. The second beam determination model may be an AI/ML based model or a non-AI/ML based model.

In optional operation VII in FIG. 6, the second communication device 300 may adapt the second beam determination model based on the determined beam evaluation or trigger the adaptation of model at the first communication device 100. The second communication device 300 may adapt the second beam determination model when the beam evaluation indicates that the performance of the set of predicted beams does not fulfill a condition, e.g., is lower than a threshold value or when other available beam determination models, as benchmarks, provide better prediction accuracy. The adaption of the second beam determination model may comprise adapting input parameter and/or coefficients of the second beam determination model or change to another second beam determination model or fallback to measurement-based beam determination. When the second beam determination model is an AI/ML based model, the second communication device 300 may e.g., adapt input parameters to the AI/ML based model or switch to another AI/ML based model or to a non-AI/ML based model. When the second beam determination model is a non-AI/ML based model, the second communication device 300 may update the algorithm parameters or change to another algorithm or to an AI/ML based model.

The second communication device 300 may perform further actions based on the determined beam evaluation. The second communication device 300 may e.g., initiate an adaptation of the first beam determination model at the first communication device 100. The second communication device 300 may also request further beam reports from the first communication device 100, e.g., a beam report 510 according to the invention for another set of predicted beams or a conventional beam monitoring report such as an uncoded and/or uncompressed beam monitoring report.

With reference to FIG. 6, in some embodiments, the second communication device 300 may configure the first communication device 100 to perform beam reporting according to the invention by transmitting a beam evaluation configuration 520 to the first communication device 100. The beam evaluation configuration 520 may indicate one or more of: reference signals to be measured, a benchmark beam, a performance metric, and a first beam determination model.

The second communication device 300 may transmit the beam evaluation configuration 520 to the first communication device 100 at different times in the procedure to e.g., configure or reconfigure beam reporting by the first communication device 100. As indicated by the optional operations VIII in FIG. 6, the second communication device 300 may e.g., transmit the beam evaluation configuration 520 to the first communication device 100 before the first communication device 100 measures the reference signals and/or determines the set of benchmark beams and/or after the first communication device 100 has obtained and transmitted the beam report 510. In embodiments, the beam evaluation configuration 520 may e.g., be or be comprised in a radio resource control (RRC) message provided by the second communication device 300 to the first communication device 100 during RRC configuration and/or RRC reconfiguration.

In embodiments, the second communication device 300 may determine the beam evaluation configuration 520 for the first communication device 100 based on the beam evaluation determined in operation VI in FIG. 6. The beam evaluation configuration 520 indicates one or more of: reference signals to be measured, a benchmark beam, a performance metric, and a first beam determination model. Depending on the information derived from the beam evaluation, the second communication device 300 may e.g., determine to change one or more of the reference signals to be measured, the benchmark beam, the performance metric, and the first beam determination model, i.e., the second communication device 300 may determine to reconfigure the beam reporting by the first communication device 100.

The first communication device 100 receives the beam evaluation configuration 520 from the second communication device 300 and hence one or more of: the reference signals to be measured, the benchmark beam, the performance metric, and the first beam determination model indicated in the beam evaluation configuration 520. Based on the beam evaluation configuration 520, the first communication device 100 measures the reference signals and/or determines the set of benchmark beams and/or determines the set of performance metrics. Operation II to III in FIG. 6 may in embodiments hence be performed based on the beam evaluation configuration 520, i.e., based on the indicated reference signals to be measured, benchmark beam, performance metric, and/or first beam determination model. However, the configuration for beam evaluation may in embodiments instead be pre-configured in the first communication device 100 or obtained from another communication device or network node.

In embodiments, the first communication device 100 may indicate its capability to the second communication device 300 related to beam reporting, i.e., its support related to jointly encoding a beam report. In this case, the second communication device 300 may determine the beam evaluation configuration 520 for the first communication device 100 further based on the indicated capabilities of first communication device 100.

FIG. 8 shows further details related to beam evaluation according to an embodiment of the invention in a 3GPP 5G context. The first communication device 100 is in this embodiment a UE and the second communication device 300 is a gNB configured for communication in a 3GPP 5G system. In the shown embodiment, the second communication device 300 triggers the first communication device 100 to transmit a beam report 510.

In operation I in FIG. 8, the second communication device 300 transmits a beam evaluation configuration 520 to the first communication device 100. The beam evaluation configuration 520 indicates one or more of: reference signals to be measured, a benchmark beam, a performance metric, and a first beam determination model.

In operation II in FIG. 8, the second communication device 300 transmits a trigger signal 530 to the first communication device 100. The trigger signal 530 indicates the first communication device 100 to transmit the beam report 510, i.e., the trigger signal 530 indicates a request for a beam report 510 from the first communication device 100. The second communication device 300 may trigger the first communication device 100 to transmit the beam report 510 e.g., based on high uplink traffic load, high interference in uplink, and/or limited latency budget, e.g., due to an emergency situation. The trigger signal 530 may be or be comprised in a medium access control (MAC) control element (CE) or a downlink control information (DCI), e.g., common DCI or dedicated DCI. The trigger signal 530 may further be or be comprised in a RRC message.

In embodiments, already existing fields in MAC-CE, DCI and/or RRC may be used and re-purposed for the triggering. Alternatively, new fields may be introduced in MAC-CE, DCI and/or RRC for the triggering.

The second communication device 300 may using the trigger signal 530 trigger or activate the first communication device 100 to report one beam report 510 or start reporting beam reports 510 aperiodically or semi-persistently. The trigger signal 530 may indicate one or more of: reference signals to be measured, a benchmark beam, a performance metric, and a first beam determination model. These fields may be included in pre-configured measurement and reporting configurations such as the beam evaluation configuration 520 and a single trigger codepoint comprised in the trigger signal 530 may be used to trigger an appropriate beam evaluation configuration.

Based on the trigger signal 530, the first communication device 100 starts to perform beam evaluation according to any of the herein described embodiments. Thus, the first communication device 100 determines a jointly encoded beam report in operation III in FIG. 8 and transmits a beam report 510 indicating the jointly encoded beam report to the second communication device 300 in operation IV in FIG. 8. The first communication device 100 may determine the jointly encoded beam report and/or transmit the beam report 510 based on information indicated in the beam evaluation configuration 520 and/or the trigger signal 530.

Depending on the trigger signal 530, the first communication device 100 may determine the jointly encoded beam report and/or transmit the beam report 510 once or continue to determine the jointly encoded beam report and/or transmit the beam report 510, e.g., periodically or event triggered, until a deactivation trigger or command is received from the second communication device 300.

In the embodiment shown in FIG. 8, the beam evaluation by the first communication device 100 is triggered by the second communication device 300 and the first communication device 100 transmits the beam report 510 to the second communication device 300 upon reception of the trigger signal 530 from the second communication device 300. The first communication device 100 may transmit the beam report 510 to the second communication device 300 over physical uplink control channel (PUCCH) and/or physical uplink shared channel (PUSCH).

In operation V in FIG. 8, the second communication device 300 determines a beam evaluation for the set of predicted beams based on the received beam report 510. The second communication device 300 may further perform one or more actions based on the determined beam evaluation, e.g., adapt the second beam determination model, as described with reference to FIG. 6.

FIG. 9 shows further details related to beam evaluation according to an embodiment of the invention in a 3GPP 5G context. The first communication device 100 is in this embodiment a UE and the second communication device 300 is a gNB configured for communication in a 3GPP 5G system. In the shown embodiment, the first communication device 100 autonomously transmits a beam report 510 based on an event.

In operation I in FIG. 9, the first communication device 100 receives a beam evaluation configuration 520 from the second communication device 300. The beam evaluation configuration 520 indicates one or more of: reference signals to be measured, a benchmark beam, a performance metric, and a first beam determination model.

In operation II in FIG. 9, the first communication device 100 measures the reference signals and/or determine the set of benchmark beams and/or determine the set of performance metrics based on the beam evaluation configuration 520 to obtain a jointly encoded beam report.

In operation III in FIG. 9, the first communication device 100 transmits a beam report 510 indicating the jointly encoded beam report to the second communication device 300. The first communication device 100 may transmit the beam report 510 to the second communication device 300 upon determining a lack of computation, energy or transmission resources for the first communication device 100. The first communication device 100 may e.g., determine that its uplink resources are limited or are experiencing interference and/or its battery capacity is limited, and based on this determine to transmit the jointly encoded beam report.

In embodiments, the first communication device 100 may transmit the beam report 510 to the second communication device 300 upon determining that a performance metric for a benchmark beam is higher than that of the first beam determination model, or upon detecting a drop in a performance metric for a benchmark beam below a preconfigured threshold. Based on the information obtained in operation II in FIG. 9, the first communication device 100 may hence determine to transmit the beam report 510 to the second communication device 300.

In operation IV in FIG. 9, the second communication device 300 determines a beam evaluation for the set of predicted beams based on the received beam report 510. The second communication device 300 may further perform one or more actions based on the determined beam evaluation, e.g., adapt the second beam determination model, as described with reference to FIG. 6.

With reference to FIG. 9, the first communication device 100 may in embodiments transmits a pre-report message 540 to the second communication device 300 prior to transmitting the beam report 510, as shown in optional operation V in FIG. 9. The pre-report message 540 indicates a reporting format of the beam report 510. The first communication device 100 may e.g., transmit the pre-report message 540 through PUCCH or PUSCH in uplink control information (UCI), MAC-CE, or by multiplexing the pre-report message 540 with data. In embodiments, the first communication device 100 may transmit the beam report 510 in an uplink configured grant (CG) and may inform the second communication device 300 about the beam report 510 triggered by the first communication device 100 with a pre-report message 540 in CG-UCI.

The second communication device 300 receives the pre-report message 540 from the first communication device 100 prior to receiving the beam report 510 and obtains the reporting format of the beam report 510 indicated in the pre-report message 540. The second communication device 300 may use the reporting format of the beam report 510 to properly receive and decode the beam report 510.

A first communication device herein may also be denoted as a network access node or a client device. A second communication device herein may also be denoted as a network access node or a client device.

A network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access node may be of different classes or types such as e.g., macro eNodeB, home eNodeB or pico base station, based on transmission power and thereby the cell size. The radio network access node may further be a station, which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

A client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant MAC and PHY interface to the WM. The UE may be configured for communication in 3GPP related LTE, LTE-advanced, 5G wireless systems, such as NR, and their evolutions, as well as in IEEE related Wi-Fi. WiMAX and their evolutions.

Furthermore, any method according to embodiments of the invention may be implemented in a computer program, having code means, which when run by processing means causes the processing means to execute the operations of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the first communication device and the second communication device comprise the necessary communication capabilities in the form of e.g., functions, means, units, elements, etc., for performing or implementing embodiments of the invention. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the first communication device and the second communication device may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

What is claimed is:

1. A first communication device for a communication system, the first communication device being configured to:
measure reference signals received from a second communication device in a set of transmit beams of the second communication device;
determine a set of benchmark beams for a set of predicted beams based on the measured reference signals;
jointly encode the set of benchmark beams to obtain a jointly encoded beam report; and
transmit a beam report to the second communication device, the beam report indicating the jointly encoded beam report.

2. The first communication device according to claim 1, configured to:
determine the set of benchmark beams based on the measured reference signals and a first beam determination model.

3. The first communication device according to claim 2, wherein the first beam determination model is an artificial intelligence/machine learning (AI/ML) based model or a non-AI/ML based model.

4. The first communication device according to claim 1, configured to:
determine a set of performance metrics for the set of predicted beams based on the set of benchmark beams; and
jointly encode the set of benchmark beams and the set of performance metrics to obtain the jointly encoded beam report.

5. The first communication device according to claim 4, wherein the set of performance metrics comprises one or more of: a beam prediction accuracy, a reference signal received power (RSRP) prediction accuracy, a signal to noise and interference ratio, (SINR) prediction accuracy, and a mismatch between a predicted beam and a benchmark beam.

6. The first communication device according to claim 4, configured to:
determine a set of beam quality quantities for the set of predicated beams based on the measured reference signals; and
jointly encode the set of benchmark beams, the set of performance metrics, and the set of beam quality quantities to obtain the jointly encoded beam report.

7. The first communication device according to claim 1, configured to:
receive a beam evaluation configuration from the second communication device, the beam evaluation configuration indicating one or more of: reference signals to be measured, a benchmark beam, a performance metric, and a first beam determination model; and
measure the reference signals and/or determine the set of benchmark beams and/or determine the set of performance metrics based on the beam evaluation configuration.

8. The first communication device according to claim 6, configured to:
quantize at least one of the set of benchmark beams, the set of performance metrics and the set of beam quality quantities based on a reference value and/or a reference resource indicator to obtain a quantized jointly encoded beam report.

9. The first communication device according to claim 8, wherein the reference value is a beam quality quantity for a benchmark beam or a predicted beam, and the reference resource indicator is a resource indicator for a benchmark beam or a predicted beam.

10. The first communication device according to claim 1, wherein the set of transmit beams of the second communication device is a set of all transmit beams of the second communication device or a subset of the set of all transmit beams of the second communication device.

11. A second communication device for a communication system, the second communication device being configured to:
transmit reference signals to a first communication device in a set of transmit beams of the second communication device;
receive a beam report from the first communication device, the beam report being a jointly encoded beam report for a set of predicted beams, the jointly encoded beam report being encoded based on a set of benchmark beams; and
determine a beam evaluation for the set of predicted beams based on the beam report.

12. The second communication device according to claim 11, configured to:
determine the beam evaluation for the set of predicted beams based on the beam report and a second beam determination model for the set of predicted beams.

13. The second communication device according to claim 12, wherein the second beam determination model is an artificial intelligence/machine learning (AI/ML) based model or a non-AI/ML based model.

14. The second communication device according to claim 12, configured to:
adapt the second beam determination model based on the determined beam evaluation.

15. The second communication device according to claim 11, wherein the encoded beam report is further encoded based on a set of performance metrics for the set of predicted beams.

16. The second communication device according to claim 15, wherein the set of performance metrics comprises one or more of: a beam prediction accuracy, a reference signal received power (RSRP) prediction accuracy, a signal to noise and interference ratio (SINR) prediction accuracy, and a mismatch between a predicted beam and a benchmark beam.

17. The second communication device according to claim 11, wherein the encoded beam report is further encoded based on a set of beam quality quantities for the set of predicted beams.

18. The second communication device according to claim 11, configured to:
determine a beam evaluation configuration for the first communication device based on the determined beam evaluation, the beam evaluation configuration indicating one or more of: reference signals to be measured, a benchmark beam, a performance metric, and a first beam determination model; and
transmit the beam evaluation configuration to the first communication device.

19. The second communication device according to claim 15, wherein the jointly encoded beam report is a quantized beam report comprising at least one of the set of benchmark beams, the set of performance metrics and a set of beam quality quantities quantized based on a reference value and/or a reference resource indicator.

20. The second communication device according to claim 19, wherein the reference value is a beam quality quantity for a benchmark beam or a predicted beam, and the reference resource indicator is a resource indicator for a benchmark beam or a predicted beam.
